(19) United States
(12) Patent Application Publication
(10) Pub. No.: US 2012/0098650 A1
(43) Pub. Date: Apr. 26, 2012

(54) Device and Method For Setting Adjustment Control

(75) Inventors: Richard Landry Gray, Saratoga, CA (US); Po Ming Tsai, Taipei (TW)

(73) Assignee: Richard Landry Gray, Saratoga, CA (US)

(21) Appl. No.: 13/279,344

(22) Filed: Oct. 24, 2011

Related U.S. Application Data
(60) Provisional application No. 61/406,142, filed on Oct. 24, 2010.

(51) Int. Cl. G05B 11/01

(52) U.S. Cl. 340/12.33

(57) ABSTRACT

A device and a method are provided for setting adjustment control for a device. The method comprises acts of generating a time base signal that is synchronized to an Alternating Current (AC) voltage, and generating a modulated AC voltage in response to an input control signal, which is referenced to the time base signal. The modulated AC voltage has a setting pattern that is formed by interrupting the AC voltage. The method further comprises acts of using the modulated AC voltage to change the device to a desired setting. The desired setting is determined from the corresponding setting pattern.

This application claims priority benefit under 35 USC 119 of Provisional Patent Application Ser. No. 61/406,142, filed 24 Oct. 2010.

### FIELD OF THE INVENTION

Embodiments of the invention relate to setting adjustments, and more particularly, to provide a device and a method for setting adjustment control.

### BACKGROUND

Much brain power is spent trying to design ballast electronics that are compatible with a phase-cut dimmer (e.g., a TRIAC dimming circuit). The phase-cut dimmer, during a dimming operation, turns off sections of the Alternating Current (AC) sinusoidal waveform seen by a load (e.g., incandescent bulbs) so that the average power dissipated in the load may be adjusted to values other than full power.

In general, phase-cut dimmers do have several undeniable benefits. Firstly, they are cheap and easy to obtain. Secondly, users like the ability to turn a knob or move a lever to obtain the desired lamp illumination, which is convenient for all. On the contrary, other user interfaces of popular dimming circuits may require some extra hardware to operate the dimming features.

However, the drawback of the phase-cut dimmer is that the power factor and harmonic distortion of the input current are usually poor. Power utilities have to overbuild their generating capacity in order to supply loads with poor power factor, which is very bad for our environment.

Therefore, there is a need for an approach to provide a mechanism or means that is compatible with a phase-cut dimmer (i.e., using the friendly interface) for a setting (brightness in the case of a lamp) adjustment without degradation in power factor.

### SOME EXEMPLARY EMBODIMENTS

These and other needs are addressed by the invention, wherein an approach is provided for a device and a method that coordinates the power (i.e., an Alternating Current (AC) voltage) to an electronic load for a setting adjustment control.

According to one aspect of an embodiment of the invention, a device for a setting adjustment control comprises a switching control unit and at least one controlled appliance. The switching control unit is connected to an AC voltage supply for receiving an AC voltage, and generates a modulated AC voltage in response to an input control signal. The modulated AC voltage is modulated from the AC voltage based on a predetermined encoding rule. The controlled appliance is connected to the switching control unit, and is driven to a desired setting according to the modulated AC voltage through a predetermined decoding rule.

In one particular embodiment, the controlled appliance may be a lighting appliance (e.g., a dimmable lamp). The switching control unit receives an input control signal from a person, and generates a modulated AC voltage. The controlled appliance interprets the modulated AC voltage as a desired brightness setting.

According another aspect of an embodiment of the invention, a method for a setting adjustment control for a device, comprises acts of generating a time base signal that is synchronized to an AC voltage, and generating a modulated AC voltage in response to an input control signal, which is referenced to the time base signal. The modulated AC voltage has a setting pattern that is formed by momentarily interrupting the AC voltage. The method further comprises an act of using the modulated AC voltage to program the device to a desired setting. The desired setting is indicated by the corresponding setting pattern.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a schematic view of the device in accordance with an embodiment of the present invention;

FIG. 2 is a circuit diagram of the switching control unit in accordance with one embodiment of the present invention;

FIG. 3 is a circuit diagram of the controlled appliance in accordance with one embodiment of the present invention;

FIG. 4 is a waveform diagram illustrates setting patterns of modulated AC voltages corresponding to the AC voltage;

FIG. 5A is a flow chart of a method for a device to adjust settings in accordance with one embodiment of the present invention;

FIG. 5B is a flow chart of a method for error checking in accordance with one embodiment of the present invention;

FIG. 5C is a flow chart of S504 for error checking in accordance with one embodiment of the present invention;

FIG. 5D is a flow chart of another embodiment to discriminate the valid state change in accordance with the present invention;

FIGS. 6A-C are exemplary illustrations indicating the valid state change in accordance with an embodiment of the present invention;

FIG. 7 is an exemplary illustration of a light appliance using the method in accordance with one embodiment of the present invention; and

FIG. 8 is a block diagram of a device having multiple controlled appliances in accordance with one embodiment of the present invention.

### DESCRIPTION OF THE PREFERRED EMBODIMENT

Devices and methods for coordinating power to an electronic load are disclosed. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the embodiments of the invention.

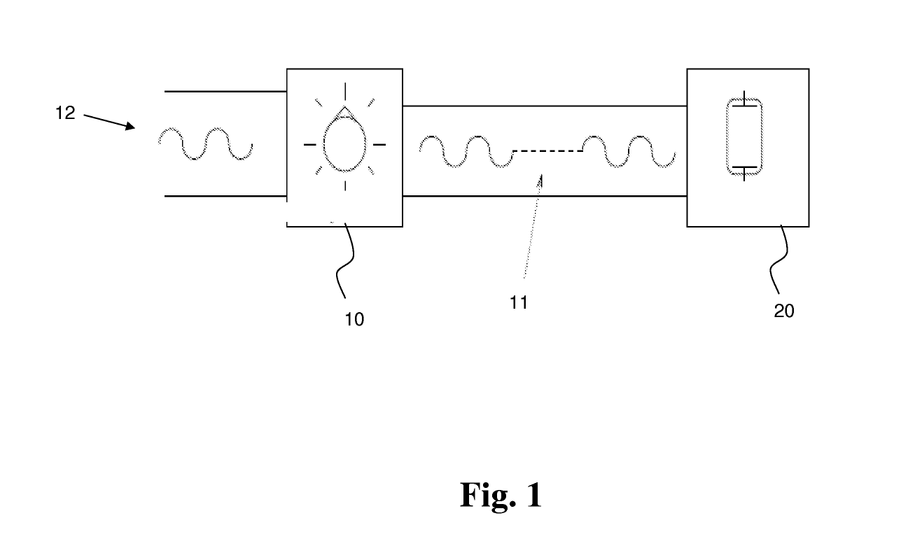

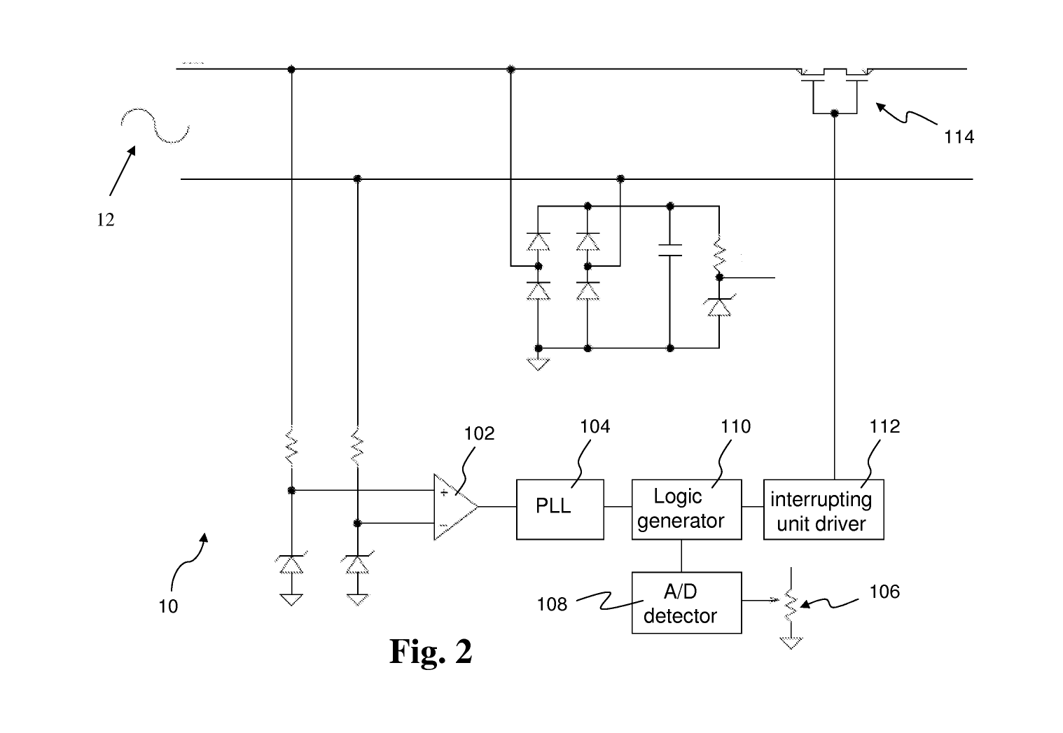

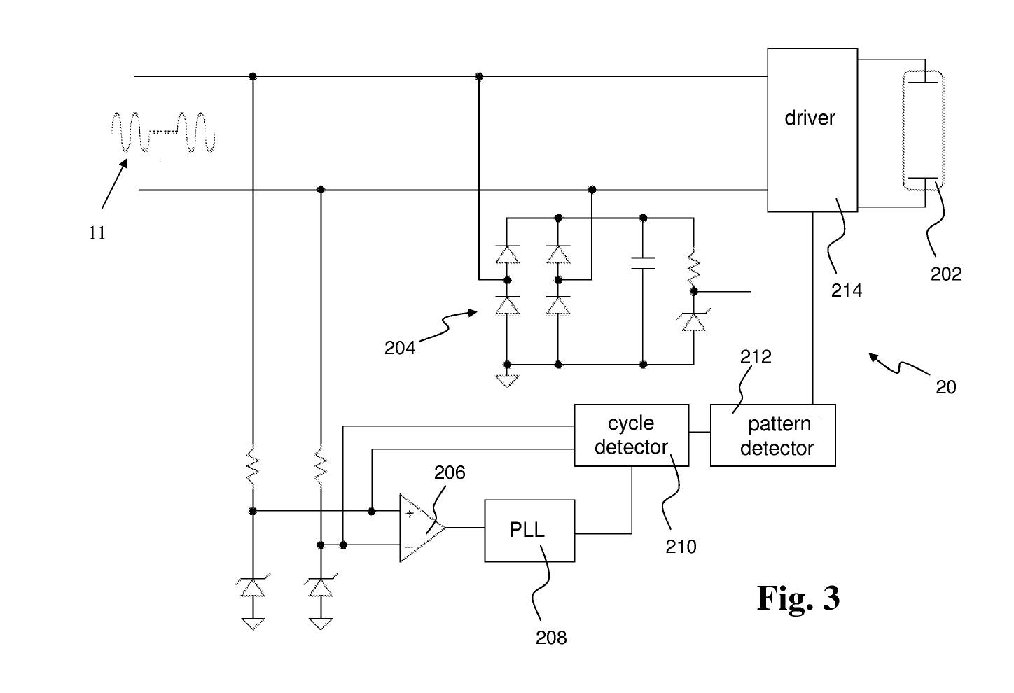

With reference to FIGS. 1, 2 and 3, FIG. 1 is a schematic view of the device in accordance with an embodiment of the present invention. FIG. 2 is a circuit diagram of the switching control unit in accordance with one embodiment of the present invention. FIG. 3 is a circuit diagram of the controlled appliance in accordance with one embodiment of the present invention. The device is connected to an Alternating Current (AC) supply (not shown) and comprises a switching control unit 10 and a controlled appliance 20.

The switching control unit 10 is connected to the AC supply, receives an AC voltage 12 from the AC supply, and generates a modulated AC voltage 11 in response to an input control signal. The modulated AC voltage 11 is modulated from the AC voltage based on a predetermined encoding rule.

The switching control unit 10, in one embodiment, comprises a zero cross comparator 102, a phase locked loop (PLL) 104, a rheostat 106, an analog-to-digital converter (A/D converter) 108, a logic generator 110, an interrupting unit driver 112, and an interrupting unit 114.

The zero cross comparator 102 is connected to the AC line voltage 12, and senses zero crossing points of the AC line voltage 12. The PLL 104 is connected to the zero cross comparator 102 and generates a first internal time base signal that is synchronized to the AC line voltage 12. Once the first time base signal is established, the switching control unit 10 is able to know the “timing” for modulating the AC line voltage 12. The rheostat 106 generates the input control signal that indicates the desired setting (or other control parameter). In order to mimic the beneficial user interface of the phase-cut dimmer as mentioned above in the background section, the rheostat 106 is analogous to the phase-cut (TRIAC) dimmer controller, which can be a knob turned by a person. The A/D converter 108 is connected to the rheostat 106 and converts the input control signal into a digital control signal.

The logic generator 110 is connected between the PLL 104 and the A/D converter 108. The logic generator 110 generates a pulse set according to the predetermined encoding rule. The interrupting unit driver 112 is triggered by the pulse set for the interrupting unit 114 to generate the modulated AC voltage 11 with a setting pattern. In embodiments, the interrupting unit can be a back-to-back MOS or a TRAIC circuit.

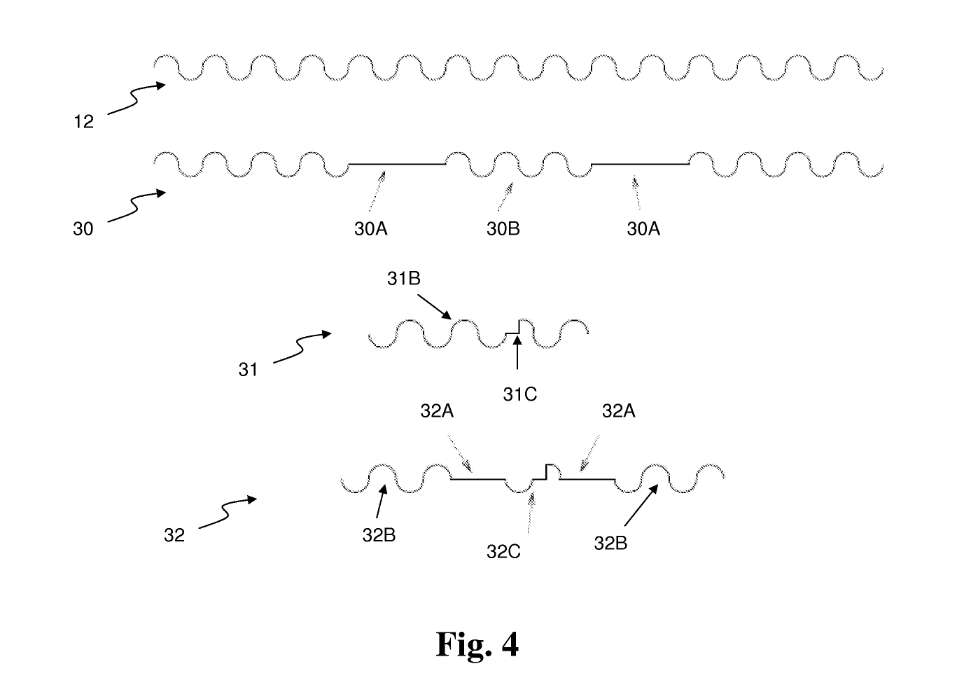

With further reference to FIG. 4, FIG. 4 is a waveform diagram illustrates setting patterns of modulated AC voltage 11 corresponding to the AC voltage. The modulated AC voltage 11 is defined as the AC voltage that has been interrupted (i.e., turned off) in a cycle and/or a portion of a cycle. The one whole cycle interruption is defined as a cycle interrupt. A cycle that is interrupted for just a portion of one cycle is further defined as a phase-cut. The interrupts/phase-cuts are determined by the predetermined encoding rule in response to the rheostat 106 (i.e., the input control signal).

As shown in FIG. 4, the first modulated voltage 30 is interrupted with two cycle interrupts 30A after three complete cycles 30B. The second modulated voltage 31 is interrupted with one phase-cut cycle 31C after one complete cycle 31B. The third modulated voltage 32 is interrupted with one cycle interrupts 32A, one phase-cut cycle 32C and two complete cycles 32B.)

The predetermined encoding rule comprises multiple sets of code. Each code set is encoded as a setting pattern of the modulated AC voltage 11. The setting pattern of the modulated AC voltage 11, shown in FIG. 4, is composed of at least one cycle interrupted, cycle phase-cut and a complete cycle. Since the modulated AC voltage 11, in view of the time base signal, is synchronized to the AC voltage, periods (durations) of the modulation of the modulated AC voltage 11 can be accurately discriminated.

With reference to FIGS. 1, 2, 3 and 4, The controlled appliance 20 is connected to the switching control unit 10 and is driven to a desired setting according to the modulated AC voltage 11 complied with a predetermined decoding rule. For example, the controlled appliance 20 may be a lighting appliance (e.g., a dimmable lamp), which interprets the modulated AC voltage 11 as a desired brightness setting.

The controlled appliance 20 receives the modulated AC voltage 11 from the switching control unit 10 and comprises a load 202 (e.g., a white light emitting diode (WLED) string), a power module 204, a zero cross comparator 206, a phase locked loop (PLL) 208, a cycle detector 210, a pattern detector 212 and a driver 214. The power module 204 comprises a rectifier and a capacitor. The rectifier is connected to the switching control unit 10, receives the modulated AC voltage 11 and is configured to provide a driving voltage. The capacitor is connected to the rectifier and is configured to withstand voltage for the controlled appliance 20.

The zero cross comparator 206 is connected to the interrupting unit 114, and receives the modulated AC voltage 11. The PLL 208 is connected to the zero cross comparator 206 and generates a second internal time base signal that is synchronized to the modulated AC voltage 11. The cycle detector 210 is connected between an input of the zero cross comparator 206 and an output of the PLL 208, and detects the setting pattern (i.e., the interrupts and phase-cuts) of the modulated AC voltage 11. Since the second time base signal has been established then the interruptions of cycles or phase-cuts can be accurately measured and interpreted.

The pattern detector 212 is connected to the cycle detector 210, is configured to determine a valid state change of the modulated AC voltage 11, and generates a programming signal according to the decoding rule when the modulated AC voltage 11 represents a valid state change. The driver 214 is connected to the pattern detector 212, the interrupting unit 114 of the switching control unit 10, and the load 202. The driver 214 drives the load 202 under the received modulated AC voltage 11 and interprets the modulation of the modulated AC voltage 11 as a variable desired setting (i.e., a brightness setting) of the load 202, which is indicated by the programming signal of the pattern detector 212.

Accordingly, as shown in FIGS. 1-3, the switching control unit 10 is connected to the controlled appliance 20 through two power supply wires (or three power supply wires if an earth ground is included), the kind found in the vast majority of modern residential or commercial wiring. In other words, the embodiment of the present invention is totally compatible with existing wiring; avoiding expensive re-wiring for power coordination for setting adjustments. The switching control unit 10 is able to communicate to the controlled appliance 20 and coordinates the AC power simply through the power wires (e.g., line voltage supply wires in your house).

However, the approached embodiments of the present invention allow that the controlled appliance 20 can be, but is not limited to, to a lighting appliance, a variable speed motor or a variable heat output appliance. For explanatory purposes, this specification uses a lighting appliance below as embodiments of the controlled appliance 20 but acknowledge that the present invention can be used with other appliances.

For example, assume a lighting appliance (i.e., a controlled appliance 20) that has 8 brightness settings. The lighting appliance interprets an absence of one cycle (i.e., the AC voltage is interrupted for a cycle by the switching control unit) of the modulated AC voltage 11 as corresponding to the first brightness setting, an absence of two cycles of the modulated AC voltage 11 as corresponding to the second brightness setting, and so on and so forth. Such absence or changes of the AC voltage are so short that they are unlikely to be noticed.

In another example, for some situations the interruptions of one whole cycle may be too long for some controlled appliance 20. The phase-cut interruption is another option that would be decoded in discrete steps. The resolution of the discrete steps could be made arbitrarily fine so that for all intents the setting (i.e., the brightness setting) control appears continuous to a person. For instance, a phase-cut interruption between 1 mS and 2 mS could be interpreted as a first setting, a phase-cut interruption between 2 mS and 3 mS could be interpreted as a second setting. Longer interruptions would correspond to higher order brightness settings.

However, it is noted that the duration of the AC voltage interrupt and lamp brightness does not have to be a linear relationship. Moreover, such modulations do not depend on a high frequency carrier being transmitted along the power lines all the time. The interruptions/phase-cuts are momentary and as such have little deleterious electromagnetic interference.

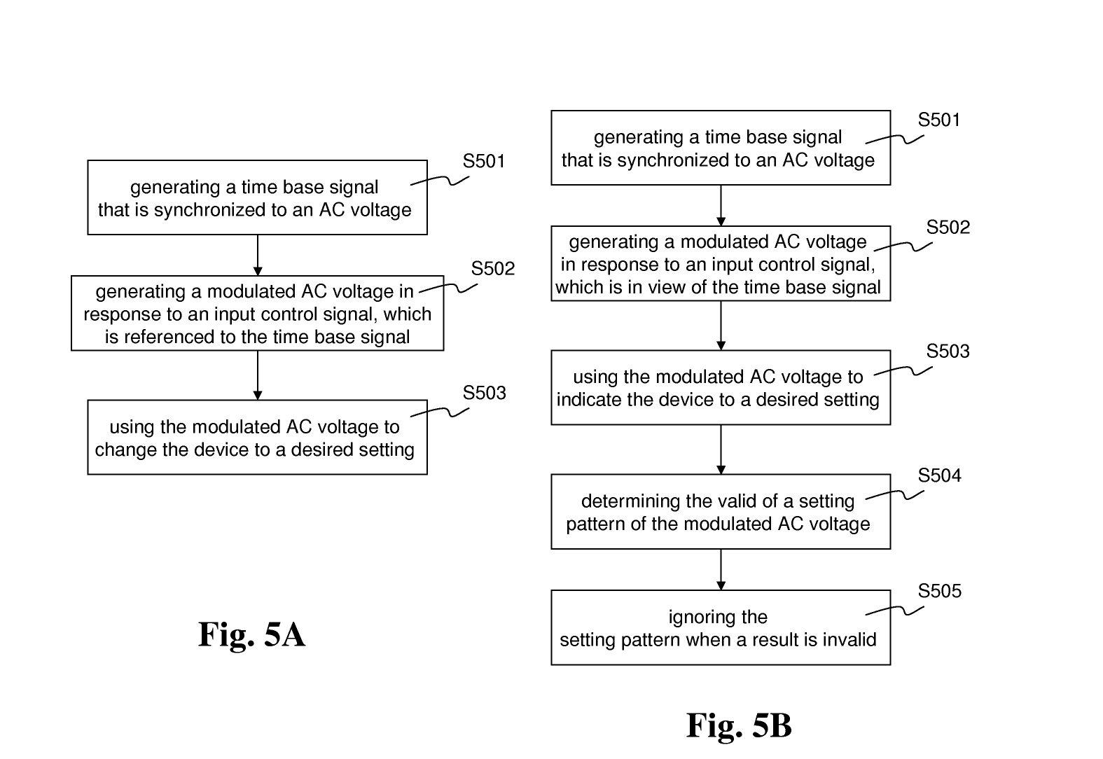

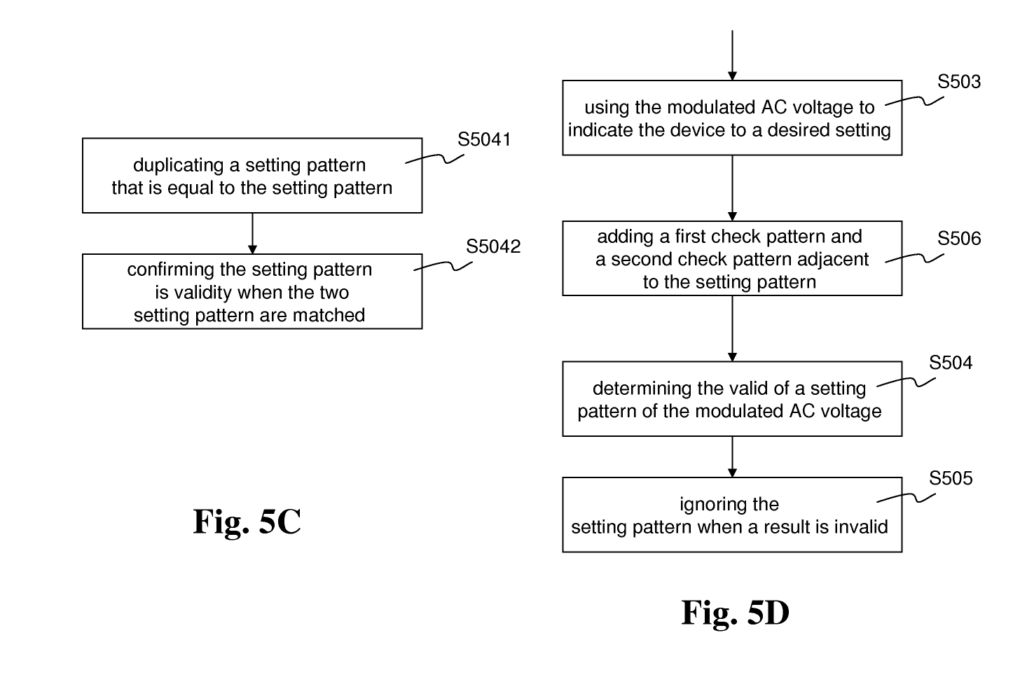

With reference to FIG. 5A, FIG. 5A is a flow chart of a method for a device to adjust settings in accordance with one embodiment of the present invention. In this embodiment, the method for setting adjustment control of a device comprises acts of S501 generating a time base signal that is synchronized to an AC voltage, S502 generating a modulated AC voltage in response to an input control signal, which is referenced to the time base signal, and S503 using the modulated AC voltage to indicate a desired setting to the device. The modulated AC voltage has a setting pattern that is formed by interrupting the AC voltage based on a predetermined encoding rule. The device interprets the setting pattern according to a predetermined decoding rule. The setting pattern indicates the device to the desired setting, and is, as mentioned above, composed of at least one cycle interrupt, cycle phase-cut and complete cycle.

With reference to FIG. 5B, FIG. 5B is a flow chart of a method for error checking in accordance with one embodiment of the present invention. In order to avoid unwanted modulations (i.e., setting patterns) due to spurious noise on the modulated AC power, the method further comprises acts of S504 determining the validity of a setting pattern of the modulated AC voltage, and S505 ignoring the setting pattern when a result is invalid.

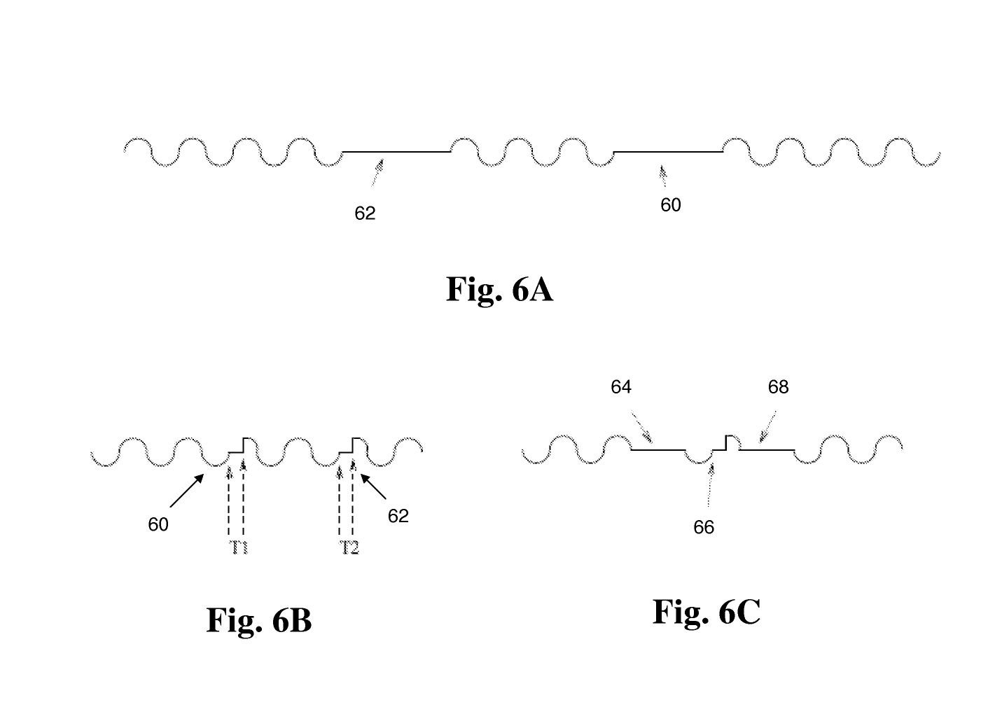

With reference to FIGS. 5C, 6A and 6B, FIG. 5C is a flow chart of S504 for error checking in accordance with one embodiment of the present invention. FIGS. 6A and 6B are exemplary illustrations indicating the valid state change in accordance with an embodiment of the present invention. One simple way to implement S504 is to make two same setting patterns before the setting pattern is deemed valid. In this embodiment, the method in step S504, comprises acts of S5041 duplicating a setting pattern 62 that is equal to the setting pattern 60, and S5042 confirming the setting pattern 60 is valid when the two setting pattern 60, 62 are matched. The equal duration of two setting pattern 60, 62 can be interpreted as matched (i.e., T1=T2 shown in FIG. 6A).

Moreover, as shown in FIGS. 5D and 6C, FIG. 5D is a flow chart of another embodiment to discriminate the valid state change in accordance with the present invention. FIG. 6C is an exemplary illustration indicating the valid state change. This embodiment comprises acts of S506 adding a first check pattern and a second check pattern adjacent to the setting pattern, respectively. In this example, as shown in FIG. 6C, the first check pattern 64 is one whole cycle interrupted, which indicates to the device that a change is coming. The setting pattern 66 follows the first check pattern 64, which indicates the change for a setting adjustment. The second check pattern 68 follows the setting pattern 66, which indicates that the previous patterns (i.e., the first check pattern 64 and the setting pattern 66) were intentionally created and not just noise spikes. In this manner the device could prepare itself to receive the modulated AC voltage and also discriminate the signal from a spurious noise signal.

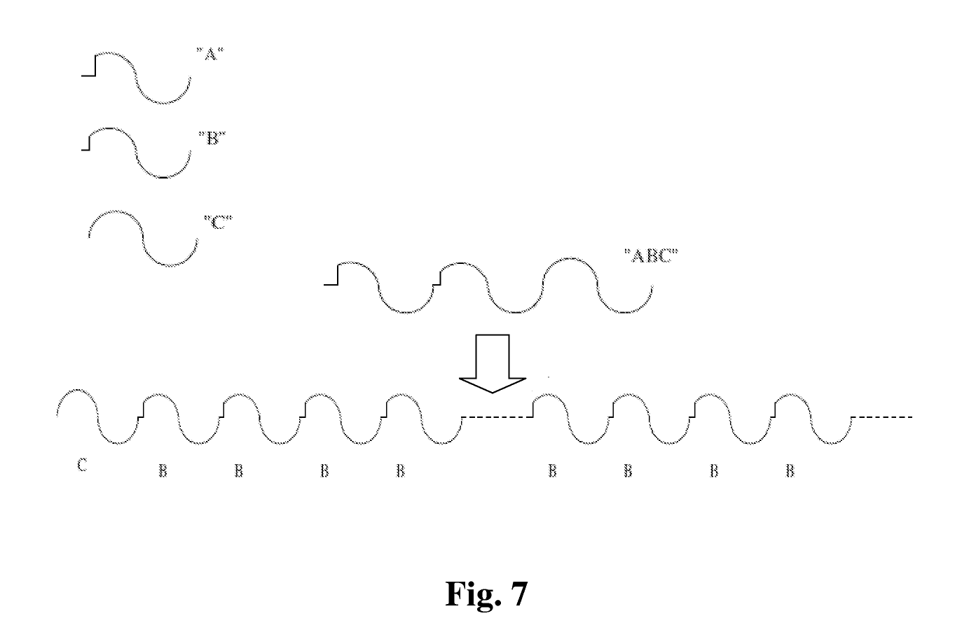

With reference to FIG. 7, FIG. 7 is an exemplary illustration of a light appliance using the method in accordance with one embodiment of the present invention. The patterns can be encoded as digital codes. In this manner, the method in accordance with embodiments of the present invention could be digitally controlled (e.g., remote control) by a computer or other timing device that process a setting adjustment (i.e., turning on and off based on the time of day).

In this example, the device is a lamp and the codes are defined such that a 30 degree phase-cut encodes an “A”, a 15 degree phase-cut encodes a “B” and no phase-cut encodes a “C”. The lamp has multiple setting patterns that indicate the brightness settings of the lamp. The setting patterns, from a view of a digital programming, are represented by a 3 digit word selected from words consisting of A, B and C. As shown in FIG. 7, one of the setting patterns is encoded as “ABC”. When the lamp is not being adjusted for a new brightness level, the lamp is programmed to ignore long streams of “C”s and continues to drive the lamp at whatever the existing brightness level is. The lamp is waiting to receive a particular code that will tell it that the brightness level needs to be changed.

In this embodiment, as shown in FIG. 7, a coding prefix (i.e., the first check pattern) is a series of “BBBB”. The lamp is programmed to know that the cycle after the 4^{th} “B” will be the beginning of a 3-cycle word (i.e., “ABC”) that describes the desired brightness setting. At the end of the desired brightness word a coding suffix (i.e., the second check pattern) of “BBBB” is again transmitted. If the first desired brightness word that was received by the lamp is identical to the second desired brightness word then the lamp brightness will be changed.

Since the phase cut is 0, 15, or 30 degrees the difference between the different phase-cut angles is relatively large so that the phase thresholds can be chosen to have high noise immunity. For instance the “A” could extend from 22.5 degrees<phase<37.5 deg, the “B” could extend from 7.5 deg<phase<22.5 deg, the “C” could extend from −7.5 deg<phase<7.5 deg.

However, since the maximum phase cut of any cycle is 30 degrees it is likely that there will be no diminution of light output from the lighting appliance while a new desired brightness word is being transmitted to the lighting appliance. This method could be extended to an arbitrarily long resolution by continuing to add more digits to the desired brightness word. The error checking algorithm could also be made arbitrarily complex at the cost of a longer programming time.

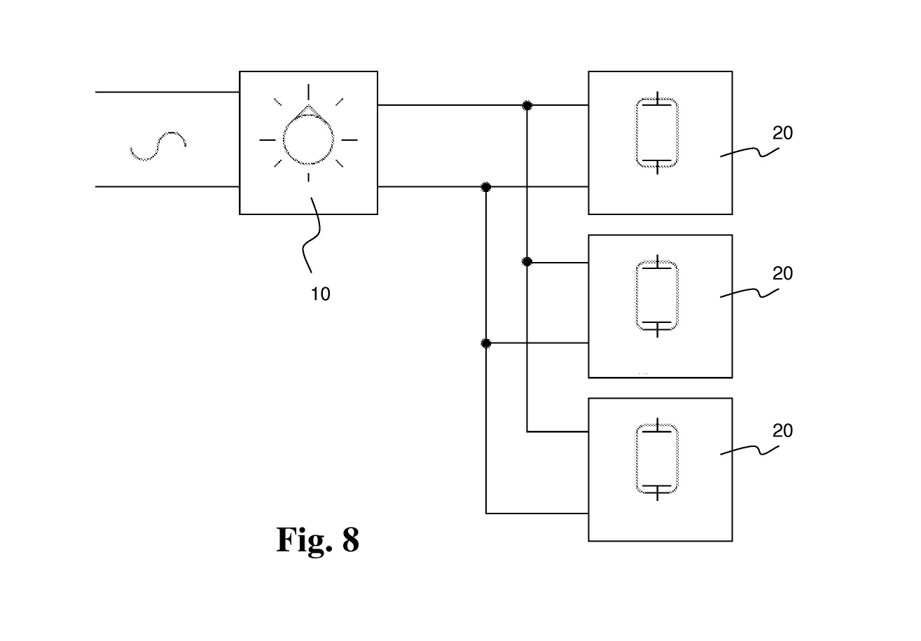

With reference to FIG. 8, FIG. 8 is a block diagram of a device having multiple controlled appliances in accordance with one embodiment of the present invention. In this embodiment, the switching control unit 10 connects to a plurality of lighting appliances 20 to form, for example, a lighting system such as stadium lights. The output settings (i.e., the brightness setting) of the controlled appliances 20 are updated on a predetermined schedule to bring the controlled appliances 20 to the same setting at one time. For instance, when the controlled appliances 20 are lighting appliances, the brightness setting could be updated on a predetermined schedule, for example, every 100 seconds, and the brightness setting could be re-transmitted to the controlled appliances 20. This would bring all loads (i.e., lamps) to the same brightness in case one of them was inadvertently set to the wrong brightness setting by a stray cosmic ray or other seldom encountered event.

Accordingly, the method could also be adapted easily to individual addressability by adding an identity pattern that corresponds to a particular controlled appliance 20. For example, in a light system having multiple lamps, the absence of two cycles can be interpreted as addressing the second lamp, and the absence of three cycles can be interpreted as addressing the third lamp.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A device for a setting adjustment control, comprising:
a switching control unit being connected to an AC voltage supply for receiving an AC voltage, and generating a modulated AC voltage in response to an input control signal, wherein the modulated AC voltage has a setting pattern that is modulated from the AC voltage based on a predetermined encoding rule; and
at least one controlled appliance, each controlled appliance is connected to the switching control unit, and is driven to a desired setting according to the modulated AC voltage through a predetermined decoding rule.

2. The device as claimed in claim 1, wherein the switching control unit comprises:
a first zero cross comparator connected to the AC line voltage, and sensing zero crossing points of the AC line voltage;
a first phase locked loop (PLL) connected to the first zero cross comparator and generate a first internal time base signal that is synchronized to the AC line voltage;
a rheostat that generates the input control signal that indicates the desired setting;
an analog-to-digital converter (A/D converter) that is connected to the rheostat and converts the input control signal into a digital control signal;
a logic generator that is connected between the first PLL and the A/D converter, and generates a pulse set according to the encoding rule; and
an interrupting unit driver that is triggered by the pulse set for the interrupting unit to generate the modulated AC voltage with the setting pattern.

3. The device as claimed in claim 2, wherein the controlled appliance receives the modulated AC voltage from the switching control unit and comprises:
a load;
a second zero cross comparator connected to the interrupting unit, and receiving the modulated AC voltage;
a second PLL connected to the second zero cross comparator and generating a second internal time base signal that is synchronized to the modulated AC voltage;
a cycle detector that is connected between an input of the zero cross comparator and an output of the second PLL, and detects the setting pattern of the modulated AC voltage;
a pattern detector is configured to determine a valid state change of the modulated AC voltage, and generates a programming signal according to the decoding rule when the modulated AC voltage indicates a valid state change; and
a driver that drives the load from the received modulated AC voltage that is indicated by the programming signal of the pattern detector.

4. The device as claimed in claim 1, wherein the switching control unit communicates to the controlled appliance through line voltage supply wires.

5. The device as claimed in claim 1, wherein the controlled appliance is a lighting appliance, a variable speed motor or a variable heat output appliance.

6. A method for setting adjustment control for a device, comprising:
generating a time base signal that is synchronized to an AC voltage;
generating a modulated AC voltage in response to an input control signal, which is referenced to the time base signal; and
using the modulated AC voltage to change the device to a desired setting.

7. The method as claimed in claim 6, wherein the modulated AC voltage has a setting pattern that is formed by interrupting the AC voltage based on a predetermined encoding rule, and the device interprets the setting pattern as the desired setting according to a predetermined decoding rule.

8. The method as claimed in claim 7, further comprising
determining the validity of a setting pattern of the modulated AC voltage; and
ignoring the setting pattern when a result is invalid.

9. The method as claimed in claim 8, wherein the act of determining the validity of a setting pattern of the modulated AC voltage comprises:
duplicating a setting pattern that is equal to the setting pattern; and
confirming the setting pattern is valid when the two setting patterns are matched.

10. The method as claimed in claim 8, comprising:
adding a first check pattern and a second check pattern adjacent to the setting pattern, wherein the first check pattern indicates to the device that a change is coming, and the second check pattern indicates to the device that the setting pattern is intentionally created.

11. The method as claimed in claim 8, wherein the setting pattern is composed of at least one cycle selected from a group consisting of an interrupt, a cycle phase-cut and a complete cycle.

12. The method as claimed in claim 8, wherein the setting pattern is encoded as digital codes, and is programmable from a computer.

13. The method as claimed in claim 6, wherein the modulated AC voltage communicates to the device through line voltage supply wires.
